(19) United States
(12) Patent Application Publication
(10) Pub. No.: US 2008/0292525 A1
(43) Pub. Date: Nov. 27, 2008

(54) Method and Reactor for Continuous Production of Semiconductor Grade Silicon

(75) Inventors: Dag O. Eriksen, Kongsberggt (NO); Oddvar Gorset, Roa (NO)

Correspondence Address: CHRISTIAN D. ABEL, ONSAGERS AS, POSTBOKS 6963 ST. OLAVS PLASS, NORWAY, N-0130, NO

(73) Assignee: INSTITUTT FOR ENERGITEKNIKK, Kjeller (NO)

(21) Appl. No.: 11/571,992

(22) PCT Filed: Jul. 1, 2005
(86) PCT No.: PCT/NO2005/000249

§ 371 Date: Jan. 30, 2007

Related U.S. Application Data
(60) Provisional application No. 60/588,322, filed on Jul. 16, 2004.

(30) Foreign Application Priority Data
Jul. 16, 2004 (NO) 20043087

(51) Int. Cl. C01B 33/03; B01J 19/00

(52) U.S. Cl. 423/350; 422/129

(57) ABSTRACT

This invention relates to a method and reactor for continuous production of semiconductor grade silicon by decomposition of a silicon containing gas of ultra-high purity to particulate silicon and other decomposition products in a free-space reactor and in which the gaseous stream of decomposition gas is set into a swirl motion. Optionally the method and reactor also includes means for melting the formed particulate silicon to obtain a continuous phase of elementary silicon, and then casting the liquid silicon to form solid objects of semiconductor grade silicon.

### FIELD OF INVENTION

This invention relates to a method and reactor for continuous production of semiconductor grade silicon.

### BACKGROUND

The presently dominant semiconductor material used in photovoltaic cells is crystalline silicon, and the material is expected to remain dominant for decades [1]. Long term forecasts predict that by year 2050, there will be a world wide need of generating annually approx. 30 PWh electricity by photovoltaic cells. Assuming this capacity is obtained only by silicon PV-cells, it must be installed a PV-capacity totalling approx. 15 million metric tonnes solar grade silicon feedstock, or about 300.000 metric tonnes annually in the coming 50 years. Presently the world annual production capacity of solar grade silicon feedstock is about 4000 metric tonnes, a figure clearly demonstrating an urgent need of significantly increased production capacity.

One major obstacle for mass-implementation of PV-cells has been a prohibitive price-level of semiconductor grade silicon. Semiconductor grade silicon is presently being sold for abut 50 US$/kg, as compared to metallurgical grade silicon at 1 US$/kg. Thus it has not been possible to produce solar panels at a price that make them competitive with net-delivered electricity, such that solar panels have been confined to remote locations without net-connection and other price-insensitive applications such as in space etc. Solar Grade Silicon, a JV between ASiMI and REC is presently the only producer of solar grade silicon determined for the photovoltaic market.

It is well known that the semiconductor and photovoltaic industry requires ultra high-purity silicon feedstock in order to obtain silicon crystals with adequate semiconductor properties. The impurity levels should be in the range of ppb(a)-ppt(a). These strict impurity level demands have ruled out conventional metallurgical production methods where liquid metal is produced by reducing a metal oxide in a furnace. Thus, all major industrial processes for producing semiconductor grade silicon feedstock involves converting metallurgical grade silicon to a volatile silicon compound, purifying the volatile compound and then decompose it to elemental silicon and by-products. These process routes may be categorised into four successive steps [2]:
1. preparation/synthesis of the volatile silicon compound
2. purification
3. decomposition to elemental silicon
4. recycling of by-products.

Presently there are four major industrial methods in use; the Siemens process, the Union Carbide process, the Ethyl Corporation process, and the Wacker process.

The Siemens process is the oldest and still most commonly used process, and involves formation of trichlorosilane by reacting metallurgical grade silicon with hydrochloric acid as step 1:

Si(s)+3HCl=HSiCl₃+H₂

The formed trichlorosilane is then purified by fractional distillation as step 2. Then the purified trichlorosilane is vaporised and introduced into a decomposition chamber (metal bell-jar reactor), where it is decomposed onto heated (about 1100° C.) surfaces of silicon seed rods to grow larger silicon rods of elemental Si (step 3). Several by-products (H₂, HCl, HSiCl₃, SiCl₄, and H₂SiCl₂) that need to be taken care of (step 4) are also formed.

The Siemens process have several disadvantages, where the most serious are: Huge energy consumption due to substantial heat losses to the cold water-chilled walls of the metal bell-jar reactor, batch-wise operation, electrical contacts are made of carbon which is a source of contamination, power failures especially during start-up, hot-spot formation, and production of large amounts of by-products.

Some of these problems have been solved by the Union Carbide process, which replaces trichlorosilane with silane, SiH₄. That is, after formation of trichlorosilane from metallurgical grade silicon metal in the same manner as in the Siemens process, silane is formed by two catalytically driven reactions:

2HSiCl₃=H₂SiCl₂+SiCl₄

3H₂SiCl₂=SiH₄+2HSiCl₃

Then the silane is separated from the product stream by distillation and purified before being sent to the decomposition chamber. The decomposition of silane to elementary silicon is, as in the Siemens process, obtained by pyrolytic decomposition onto heated seed rods of silicon inside a chilled metal bell-jar reactor:

SiH₄=2H₂+Si

Thus the Union Carbide process is also a batch process, but have a major benefit over the Siemens process in that the silane decomposition reaction may be performed at significantly lower temperatures, which means correspondingly savings in energy consumption. Other benefits are that the silane decomposition process is complete, no corrosive by-product is formed, only H₂-gas, and the process forms uniform large diameter rods free of voids. The disadvantage is that, in addition to the batch-wise production, the conversion of trichlorosilane to silane involves additional process steps and thus a higher price of the volatile silicon compound, as compared to the Siemens process.

### PRIOR ART

It is well known that in general, batch-wise production lines are more cost-inefficient than continuous production lines. Thus, there should be developed continuous high-throughput production lines in order to make semiconductor grade silicon based product more price-competitive on the market.

The Ethyl Corporation process is a continuous production line for semiconductor grade silicon, in which there is made two radical changes in regard to the Siemens and Union Carbide processes. The first change is that it uses silicon fluoride as raw material, which is transformed into silane. The second radical change is that instead of using static silicon seed rods inside a metal bell-jar reactor, it is employed dynamic seed spheres of silicon inside a fluidised bed reactor. In addition to the benefits of employing pyrolytic decomposition of silane, this process allows use of large reactors with high continuous through-flows, both for reactant and products.

However, the Ethyl Corporation process is encumbered with problems of powder formation due to homogeneous composition of silane and adsorption of hydrogen into the silicon deposition layer. The Wacker process also uses a fluidised bed reactor, but uses trichlorosilane and hydrogen as input.

Solar Grade Silicon is presently testing a new fluidised bed process based on decomposition of silane. A plant in full operation is announced for 2005.

### OBJECTIVE OF THE INVENTION

The objective of this invention is to provide a method and reactor which allows continuous high-throughput production of semiconductor grade silicon.

A further objective of this invention is to provide a method and reactor for continuous high-throughput production of semiconductor grade silicon which solves the problem of powder formation and hydrogen adsorption into the silicon metal.

### SUMMARY OF THE INVENTION

The objectives of this invention may be obtained by the features disclosed in the following description and/or the appended claims.

This invention concerns continuous production of ultra-high purity silicon metal by decomposition of an ultra-high purity stream of silicon containing gases to silicon metal in a decomposition reactor, such as for instance silane to silicon metal and hydrogen gas:

SiH₄=2H₂+Si

Further, as opposed to prior art, this invention is based on the realisation that the formation of silicon powder due to homogeneous decomposition of silane may be an asset instead of a problem. That is, by regulating the decomposition conditions to maximise the formation of silicon powder, it becomes possible to obtain a complete decomposition of silane to silicon particles/dust and hydrogen gas in a free space reactor. The dust/particles may then be converted into a continuous metallic phase by heating the particles/dust until they melt and forms a liquid metal, followed by a casting process to form solid metallic objects of ultra high-purity silicon.

Ultra-high purity is meant to represent contamination levels in the range of ppt(a)-ppb(a) or less for each contaminant. It is envisioned that the invention may employ a similar process for obtaining ultra-high purity silane as in the Union Carbide process where metallic grade silicon is reacted with hydrochloric acid to form trichlorosilane, which is finally catalytically converted to silane. However, as mentioned above, any conceivable process route for silane may be implemented into this invention as long as it provides a continuous supply of sufficient amounts of ultra-high purity silane gas. This may include implementation of any conceivable production facility of silane to simply delivering silane in tanks, pipes etc.

One great advantage of aiming for forming silicon dust/particles as an intermediate product is that the use of a solid phase seed material (silicon) to obtain the decomposition to elementary silicon is no longer needed, and this in itself simplifies the process considerably since it may be performed in open space reactors. Another advantage is that the entire process may be performed in a free gas stream through the reactor space, a feature which allows use of conventional gas-phase reactors which may be run continuously with high through-flow volumes, such as gas cyclones etc.

The main conditions for obtaining a continuous gas-phase decomposition of silane to silicon powder and hydrogen gas are gas temperatures of above approx. 600° C. and a sufficiently strong and confined gas flow inside the reactor to entrain and transport the silicon particles in order to avoid excessive deposition of silicon on the inner reactor walls.

After the decomposition stage, the formed silicon particles should preferably be subject to a melting zone in order to form a continuous metallic phase from the silicon particles/dust, and to obtain a complete separation of the silicon phase and the gas phase. Alternatively the silicon powder may be collected by conventional means such as settling, filtering, cyclone separation etc. before the melting of the silicon particles. Subsequent casting of silicon ingots may be performed in a separate stage and process equipment. However, in order to minimise the possibilities of introducing contaminants in the liquid metal phase, it is preferred to include a melting and collection section in the decomposition reactor directly downstream of the decomposition section, and only supply the reactor with the ultra-high purity silane gas upstream of the decomposition stage. In this manner the only elements that are supplied to the reactor are Si and H, including minute amounts of contaminants from the ultra-high purity silane gas.

It may be advantageous to dilute the silane gas in order to ensure sufficient gas amounts to obtain an adequate entrainment of the silicon dust/particles. In this case it is preferred to employ pure hydrogen gas, which is readily available after decomposition stage in the process. Thus there may optionally be implemented a recycling route to allow reintroduction of at least parts of the formed hydrogen gas into the decomposition stage of the reactor, and there may also be available an external supply of hydrogen for the start-up phase. Such features are known to a skilled person and need no further description.

The melting of the silicon particles may be obtained by heating the gas stream in the melting zone of the reactor to a temperature above approx. 1250° C. The heating of the gas stream may be obtained by any conceivable method, for instance by introducing heating coils on the outer walls of the reactor, admixture with a hot inert media, employ a plasma arc inside the reactor, induction zones, radiant heating etc. It is preferred to employ an external heat source, such as heating coils in order to eliminate the possibilities of introducing contaminants into the melting zone of the reactor.

The decomposition reactor may advantageously be equipped with means for collecting and maintaining the liquid silicon in the liquid phase, and means for performing controlled tapping and casting of the silicon in order to form ingots of semiconductor grade silicon. These may include means for performing tapping and casting in an inert atmosphere and/or means for performing the tapping and casting in a reduced pressure/vacuum in order to reduce the contamination of the liquid metal to a minimum. Such means are conventional technology for treating, form shaping, casting etc., semiconductor grade silicon, and need no further description.

Despite that the description of the invention is related to the use of the metal in the photovoltaic industry, one should have in mind that the invention produces pure metallic objects which may be applied for any known application of such metal, in pure state, in alloyed state or as a composite material. The silicon metal produced by the inventive method may also be subject to CZ-growth to form monocrystalline silicon.

There is a problem with silicon deposition on the inner surfaces of the reactor. Furthermore, there is a challenge in handling expanding gas volumes in the decomposition reactor during decomposition of silane to silicon dust and hydrogen gas. In conventional plug-flow reactors, the typical solution for handling expanding flows have been to decrease the flow velocities in order to control the pressure increase. This approach will obviously increase the problem of scaling. Another consequence of decreasing the flow velocities is that the heat transfer between the reactor walls and flow becomes correspondingly poorer due to increased boundary layers close to the walls. On the other hand, if one attempts to handle the scaling problem by increasing the flow-through velocity, the residence time will be correspondingly shortened. This may be compensated by lengthening the plug-flow reactor, but offers no solution to the problem with pressure build-up inside the rector. On the contrary, the increased flow velocities will actually contribute to increase the pressure build-up due to the expanding flow volume. Furthermore, in cases where the flow expansion is due to formation of gaseous products, the pressure increase in the reactor is disadvantageous from a production yield perspective since a pressure increase usually means reduced reaction kinetics and a tendency to shift the chemical equilibrium toward the reactant side of the reaction.

Thus, in a second aspect of the invention, these problems have been solved by employing through-flow free-space reactors where the stream of reactants and formed products is set in a swirl motion through at least the decomposition section of the reactor.

A swirl flow is characterised by a flow velocity with tangential velocity components that are significantly different from zero and with radial velocity components close to zero. All imaginable fractions of tangential to axial velocity components may be applied; smaller than one, one, and higher than one.

A swirl flow gives several benefits:
Increased flow velocity close to the reactor wall, which causes a higher fraction of particulate silicon to remain entrained in the flow, and thus reducing the problem of deposition of a silicon layer correspondingly.
The swirl flow will typically be denser (concentrated) at the outer perimeter (close to the walls), while in the middle section close to the centre line of the reactor the flow will be less dense. Thus the centre portion of the reactor will act as an expansion zone that is available for taking up the expanding flow volume due to formation of hydrogen gas, and thus avoiding a substantial pressure increase in the reactor. The hydrogen gas may be selectively extracted by an optional central membrane, comprising titanium, palladium or any other hydrogen permeable solid.
The swirl motion will give a longer path length for the flow through the reactor, which allows for larger flow velocities without need for extending the reactor design.
The strongly increased flow velocities close to the reactor walls may enhance the heat transfer coefficient across the “flow/reactor wall”-boundary by several magnitudes, and thus allow a substantially more efficient heating or cooling of the reactant flow in the reactor when employing an external heating or cooling medium contacting the outside of the reactor.

In summary, the swirl flow gives benefits in that it significantly reduces fouling on the inner walls of the reactor, the increased heat transfer characteristics make it possible to down-size the process equipment, the problems with pressure increase due to increased gas volumes are significantly reduced, and the gas keeps its focused, concentrated flow pattern, making it easier to handle the flow downstream of the reactor.

As used herein, a through-flow free-space reactor means a reactor space confined by a more or less elongated hollow object that is open in both ends, and where the reactant flow enters into one open end, travel through the hollow interior of the reactor before exiting at the other end. Design of the reactor and the up and downstream sections are of great importance. Circular inner ducting is of course important in order to enhance swirl motion, and is therefore a preferred feature of reactors according to the invention. This circular ducting can be implemented as cylindrical or as conical parts with varying cone angles.

The means for setting the flow in swirl motion may be of any conventional mean known to a skilled person. Examples of such means are by tangential injection of flow by one or more nozzles or injection lances in the inlet section or discretely or continuously along the cone/cylinder axis, by static or dynamic rotors, or guide vanes. Swirl intensity can be described by the swirl number. In the case of injection lances, the injection angle is an important parameter for control of the swirl number.

The flow may be set into swirl motion before entering the reactor space, it may be set into swirl motion in the upper (upstream) section of the reactor space, or it may be maintained, or even strengthened, by any conventional active or passive swirl generating means.

Swirl flow may be used to “sweep” the inner surfaces of the reactor clean for deposits. This may be obtained by constantly or intermittently regulating the tangential angle in which the jet stream is inserted. By doing so, the flow pattern of the swirl flow through the reactor will change, and thus the intense regions of the swirl flow will change its localisation inside the reactor accordingly. This feature may be employed to “sweep” clean all inner walls of the reactor for deposits. Cyclic variation-patterns are especially suited, since they will cause a swirl flow that change in a correspondingly cyclic pattern and thus regularly sweeps the most intense part of the swirl flow over each section of the inner walls of the reactor. In this way, no stable regions of relatively calm flow regimes will be formed where solid particles are given time and opportunity to attach the inner walls of the reactor. An alternative method that obtains the same effect is to keep the injection nozzle(s) or lance(s) stationary, and instead rotate the reactor body around its centre axis. Yet another alternative embodiment is rotating the injection means along the circular perimeter of the reactor inlet, while keeping the reactor body stationary. Also mixes of these embodiments may be favourable.

Other important parameters are circular diameter and length of sections, and gas flow. Together with the swirl number, these parameters fix the residence time of the flow in the different sections.

### LIST OF FIGURES

FIG. 1 shows a longitudinal cross-section view of a first embodiment of a reactor for performing the inventive method of decomposing silane to silicon metal.

FIG. 2 shows a longitudinal cross-section view of second embodiment of a reactor for performing the inventive method of decomposing silane to silicon metal.

FIG. 3 is a graphic representation of verification tests on different flow characteristics of swirl flows compared to non-swirl flows in pipes with expanding gas flows.

### DESCRIPTION OF REACTORS

The invention will be described in greater detail under reference to preferred embodiments of decomposition reactors for performing the inventive method of decomposing ultra-high purity silane to metallic silicon and hydrogen gas. These embodiments should not be considered as a limitation of the practical implementations of the inventive idea of performing the decomposition of silane in the gas-phase. The inventive method may be performed in known conventional high-throughput gas-phase reactors, such as gas cyclones etc.

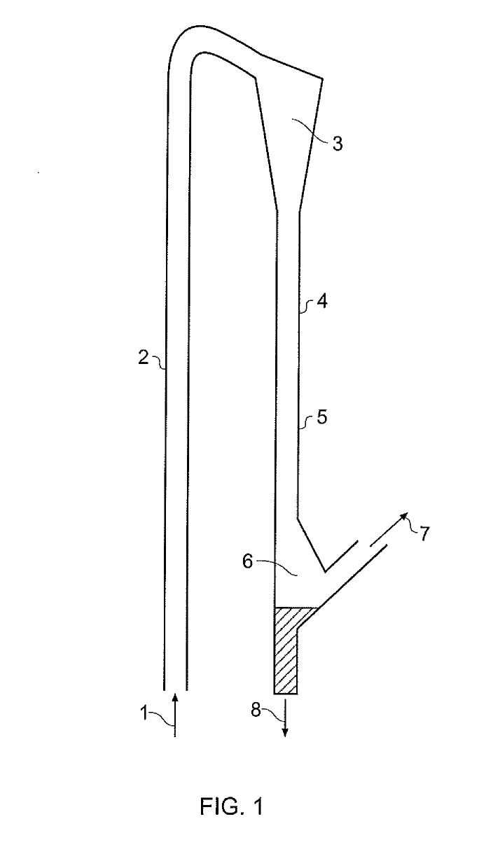

The working principle of the inventive method may be illustrated by describing the principle components of a first embodiment of a preferred reactor for decomposing ultra-high purity silane gas to silicon for production of semiconductor grade silicon. The reactor is shown schematically in FIG. 1.

A stream of ultra high-purity silane gas, optionally diluted by admixture with hydrogen gas or an inert gas, is led into the reactor through inlet 1. The silane gas stream, or optionally silane gas and dilution gases, may optionally be passed through a first heating section 2 where the gas(es) is/are preheated. It is reported in the literature that the silane decomposition takes place in a temperature interval from 300 to 1300° C. Experiments performed by the inventors show that the preheating should give a silane stream with a temperature in the range of 250 to 500° C., preferably in the range of 250 to 300° C. After preheating, the silane gas is led into the decomposition chamber 3 in such a way that a swirl flow along the inner surface is created, for instance through nozzles, guide vanes or rotating machinery (not shown). The silane stream, which now is put into a swirl motion, is then heated to decomposition temperature where silane decomposes to amorphous silicon dust and hydrogen gas. The temperature of the gas leaving the decomposition stage should be in the range from 500 to 1300° C., preferably from 600 to about 800° C., or most preferably around 650° C. Then the flow is led to a third heating section 4, preheating to almost melting, and further to a fourth heating section 5, where the flow is heated to a temperature where the amorphous silane melts, agglomerates and settles into a liquid metal phase. Thus the gaseous phase (hydrogen gas) is separated from the metal phase in section 6, and the liquid metal is tapped down into a collection mean 8 (not shown). The temperature of the gas leaving heating section 5 should be in the range of 1200 to 1500° C., preferably 1200 to 1300° C., and most preferably around 1250° C. The hydrogen gas is led out through outlet 7 and collected for further processing, as diluting agent for the silane gas entering inlet 1 etc.

Sections 2-5 of the reactor presented in FIG. 1 have inner circular cross-sections, such that they are cylinders except section 3 which is given a conical shape. The heating of each section is provided by heating coils circumventing the outer surface in each heating section 2, 4, and 5.

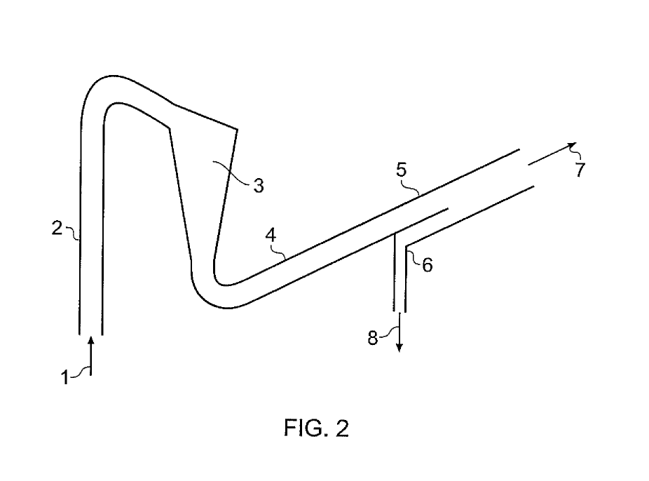

FIG. 2 shows an alternative embodiment of a reactor for decomposing silane to silicon and hydrogen gas according to the inventive method. This embodiment of the reactor is similar to the reactor shown in FIG. 1, with the exception that the circular duct forming the second and third heating sections 4,5 is upwardly protruding, and in that the melting section 5 is equipped with an opening/slot in the bottom to allow melted silicone to exit into a lower collection chamber in communication with collection mean 8 (not shown) for liquid metal.

The preferred embodiments of reactors for performing the inventive method of decomposing silane to elementary silicon and hydrogen gas, may include means for further processing of the product stream exiting the reactor. These means may be any conventional means known to a skilled person for subsequent processing of the product stream, including but not restricted to, mean(s) for refining the product(s), mean(s) for admixing in additional compound(s) in either solid, liquid of gaseous phase into the product stream, mean(s) for separating specific compounds, phases in the product flow, mean(s) for heat treating the product stream etc. It is also envisioned to employ separate reactor inlets for the reactants, for example one injection nozzle or lance for each reactant arranged such that the reactants are mixed and forced to travel through the reactor in a swirl flow. This embodiment allows using reactants that react spontaneously with each other.

### Verification Test of the Inventive Method

The feature of employing swirl-motion to ease the handling of expanding flows has been tested in order to verify the invention.

The tests are performed on two reactors, one cylindrical and one conically convergent reactor. The cylindrical had an inner diameter of 50 mm and length of 1000 mm. The conically shaped reactor had an inner diameter of 83 mm at the inlet and 32 mm at the outlet, the length was 910 mm.

The injection of the gas was done through a lance with inner diameter of 6 mm and positioned such that the gas stream entered the reactor tangentially related to the centre-axis of the reactor. The angle in relation to the centre-axis was varied between 22.5 and 68.7°. The gas was air, from 22 to 57 l/minute (at standard temperature and pressure) and which had a velocity of 13 to 33 m/s when exiting the lance. In order to create an expansion of the flow volume, the reactor walls were heated such that the air temperature was doubled. The air, which had a temperature of approx. 300 K when inserted into the reactor, was heated up to approx. 600 K before exiting. The residence time in the reactor was from 0.5 to about 4.5 s.

The effect of varying cone angles on the flow characteristics were investigated, with cone angles ranging from 0 degrees (implying a cylinder) to 45 degrees. These design alterations were tested on both converging (reducing) and diverging (diffusing) cones. Combinations of sections of different cone angles were also tested.

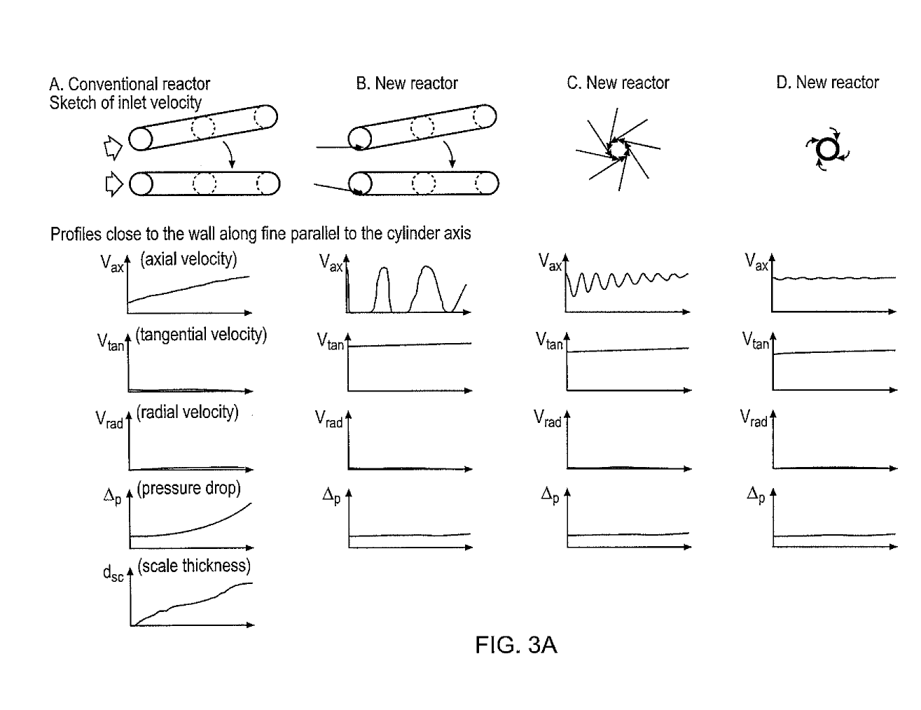

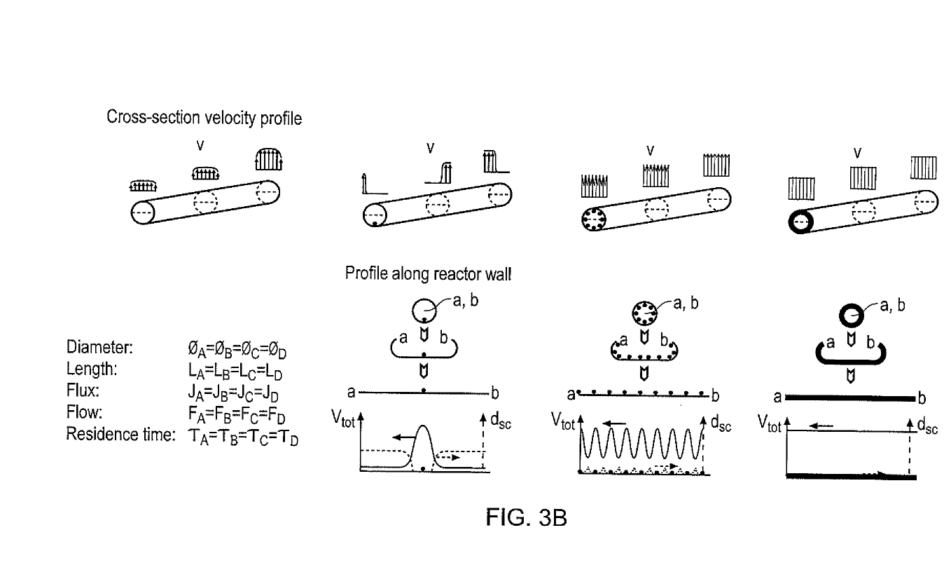

FIG. 3 shows qualitatively the pressure build-up and flow velocities in tangential, axial, and radial direction for the cylindrical reactor, as well as the scale depositions on the reactor walls. The results are given for conventional flow (no swirl), and swirl flow induced by one lance, eight lances evenly disposed along the circumference and for a large number of lances (mimics a homogeneous flow distribution along the circumference).

From the Figure it is clear that the conventional flow without swirl, the axial velocity increases and the gas pressure increases along the axis. For the reactor with swirl flow, the increase in pressure drop is almost zero along the axis, showing that the swirl flow is able to “swallow” the increasing gas volume. Also, the plots over tangential flow velocities show that the swirl flow is not significantly degenerating on its way through the reactor. This helps to reduce scale deposits throughout the reactor.

### REFERENCES

1. Handbook of Photovoltaic Science and Engineering, Edited by A. Luque and S. Hegedus, 2003, John Wiley & Sons, Ltd., pp. 153-154.
2. Handbook of Photovoltaic Science and Engineering, Edited by A. Luque and S. Hegedus, 2003, John Wiley & Sons, Ltd., pp. 167-175.

1. Method for continuous production of semiconductor grade silicon, where a stream of a silicon containing gas of ultra-high purity is decomposed to form silicon metal,
characterised in that the method comprises the following steps:
decomposing the silicon containing gas in a free-space reactor to form silicon metal substantially as silicon dust/particles, and
setting the silicon containing gas in a swirl flow through the decomposition stage in the reactor.

2. Method according to claim 1,
characterised in that the method also comprises means for maintaining the swirl flow of gas through the reactor in the process steps downstream of the decomposition stage.

3. Method according to claim 1 or 2,
characterised in that the method also comprises:
melting the formed silicon dust/particles to obtain a continuous phase of elementary silicon, and
casting the liquid silicon to form solid objects of semiconductor grade silicon.

4. Method according to claim 1,
characterised in that the swirl flow is obtained by employing tangential injection of the silicon containing gas into the decomposition stage of the reactor, and in that the injection angle is intermittently changed in order to “sweep” clean the inner surface of the reactor for deposits.

5. Method according to claim 1 to 4,
characterised in that the silicon containing gas is silane.

6. Method according to claim 1 to 4,
characterised in that the silicon containing gas is trichlorosilane.

7. Method according to claim 5,
characterised in that the silicon containing gas is silane diluted by an ultra-high purity inert gas or ultra-high purity hydrogen gas.

8. Method according claim 5 or 7,
characterised in that the gaseous flow of silane is heated to a temperature in the range of 500 to 1300° C., preferably in the range of 600 to 800° C., and most preferably about 650° C. in the decomposition section in the reactor.

9. Method according to claim 8,
characterised in that the gaseous flow of decomposition products is heated to a temperature in the range of 1200 to 1500° C., preferably in the range of 1200 to 1300° C., and most preferably about 1250° C. in the melting section of the reactor.

10. Reactor for decomposing a silicon containing gas to elementary silicon,
where the reactor is a tubular and/or conical reactor which is rotational symmetric along the centre axis, and
where the reactor in one end comprises an inlet for a gaseous stream of a silicon containing gas, a decomposition section where the silicon containing gas is decomposed to form elementary silicon in metallic phase and other decomposition products, a separation section where the metal phase is separated from the other decomposition product(s) and eventual residue(s) of the silicon containing gas stream, and an outlet section in the other end including separate outlets for the metal phase and the other phase(s),
characterised in that one or more of the sections comprise:
means for setting the flow of silicon containing gas into a swirl motion, and
means for heating the silicon containing gas flow to desired temperatures.

11. Reactor according to claim 10,
characterised
in that the decomposition sections is an open space section which comprises:
means for setting the flow of silicon containing gas into a swirl motion before entering the decomposition section, and
means for heating the silicon containing gas flow inside the decomposition section to a temperature which causes the silicon containing gas to decompose to particulate silicon and further decomposition product(s),
in that the separation section comprises:
means for heating the formed particulate silicon and other decomposition product(s) up to a temperature where the silicon particles melt and agglomerates, and
means for collecting the molten silicon in order to form continuous phase of silicon metal and to obtain a separation of the silicon metal phase from the other decomposition product(s),
and in that the outlet comprises:
means for tapping the molten silicon metal, and
means for leading the stream of further decomposition products(s) out of the reactor.

12. Reactor according to claim 10 or 11,
characterised in that the design of the decomposition section of the reactor chamber is either; cylindrical, conically diverging (diffusing), conically converging (reducing), or combinations of these shapes.

13. Reactor according to claim 10 or 11,
characterised in that the heating means for heating the flows inside the reactor comprises conventional heating means such as heating coils on the outer walls of the reactor, means for admixing the stream of a silicon containing gas with a hot inert media, means for providing a plasma arc inside the reactor, means for providing induction zones inside the reactor, means for contacting the gaseous stream with radiant heating, etc.

14. Reactor according to claim 13,
characterised in that the heating means for heating the gas inside the decomposition and separation section are electric heating coils on the outer walls of the reactor's decomposition section and separation section, respectively.

15. Reactor according to any of claim 10 to 14,
characterised in that the means for setting the flow of gas inside the reactor in a swirl motion comprises injection jet(s) made by one or more injection lances or one or more injection nozzles, or a combination of these, and that the injection means is/are arranged at a tangential angle into the upstream inlet of the decomposition section of the reactor.

16. Reactor according to claim 15,
characterised in that the injection lance(s) or nozzle(s) is/are equipped with means for regulating the tangential insertion angle in cyclic patterns.

17. Reactor according to claim 15,
characterised in that the injection lance(s) or nozzle(s) is/are rotated along the circular perimeter of the reactor inlet, or alternatively, that the injection lance(s) or nozzle(s) is/are stationary and that the reactor is rotated along its centre axis.

18. Reactor according to claim 10 or 11,
characterised in that when the silicon containing decomposition gas is silane, the centre of the reactor is equipped with means for selectively removing formed hydrogen gas.

19. Reactor according to claim 17,
characterised in that the means is a membrane which comprises titanium, palladium or any other hydrogen permeable solid.
